(19) United States
(12) Patent Application Publication
(10) Pub. No.: US 2026/0359100 A1
(43) Pub. Date: Nov. 12, 2026

(54) SYSTEM AND METHOD FOR EXECUTING SOFTWARE TASKS VIA INTERFACE-LEVEL AI ASSISTANCE

(71) Applicant: Friction Free Dental, Inc., Boston, MA (US)

(72) Inventor: Kevin Farrell, Boston, MA (US)

(21) Appl. No.: 19/674,521

(22) Filed: May 12, 2026

Related U.S. Application Data
(60) Provisional application No. 63/804,038, filed on May 12, 2025.

(51) Int. Cl. G06F 9/48

(52) U.S. Cl. CPC G06F 9/4843

(57) ABSTRACT

An artificial intelligence (AI) platform and method. The platform includes: an interface configured to handle requests to receive, process, and save data at disparate systems that have different graphical user interfaces (GUIs) and that store data in different formats; and a vision-enabled AI interface (VAI) system configured to receive a task request from the interface and perform processes that include: deploy a task level model selected from a plurality of task level models trained to perform the task request for an associated disparate system; execute the task level model to control a vision sensor unit (VSU) and a device controller unit (DCU) to implement the task request without human intervention via an associated dental practice system GUI; and deploy a system level model in response to an error encountered by the task level model.

### CROSS REFERENCE TO RELATED APPLICATIONS

This application claims priority to co-pending provisional application number 63/804,038, filed May 12, 2025, the contents of which are hereby incorporated by reference.

### FIELD OF THE INVENTION

This invention relates generally to automated software operation and artificial intelligence, and more specifically to systems and methods for performing tasks within existing software environments through interface-level interaction, without requiring direct access to application programming interfaces (APIs).

### BACKGROUND

Traditional software automation depends heavily on application programming interfaces (APIs), which are costly to build, maintain, and often unavailable especially in legacy systems. As a result, organizations frequently rely on manual operations for routine tasks.

Robotic process automation (RPA) tools have evolved over the last decade to help bridge this gap but with limited success. They depend on brittle screen-scraping methods and predefined scripts that are not resilient to interface changes or contextual variability and often operate unsupervised by the user when needed.

### SUMMARY OF THE INVENTION

The disclosed system and method for executing software tasks via interface-level AI assistance enables a software system to mirror user behavior within existing software environments without relying entirely on direct API integration. Rather than accessing back-end code or interfaces, the system interacts with the graphical user interface (GUI) in the same way a human user would, i.e., utilizing external computing device controls and requiring no internal system knowledge or access.

The system includes a trainable knowledge engine that learns the workflows, task sequences, and operational logic of a given application. Once trained, it mirrors the behavior of a skilled user to fulfill requests with precision and consistency, using only computer vision and device-level control. By eliminating the need for tightly coupled integrations or source-level modifications, the system supports rapid deployment in both modern and legacy software environments—including those with no available APIs—while adhering to standard user permissions and usage boundaries. This approach offers a compliant, flexible, and scalable alternative to traditional automation methods such as robotic process automation (RPA).

In one aspect, an artificial intelligence (AI) platform implemented in a server is provided, comprising: an interface configured to handle requests to receive, process, and save data at disparate systems that have different graphical user interfaces (GUIs) and that store data in different formats; and a vision-enabled AI interface (VAI) system configured to receive a task request from the interface and perform processes that include: deploy a task level model selected from a plurality of task level models trained to perform the task request for an associated disparate system; execute the task level model to control a vision sensor unit (VSU) and a device controller unit (DCU) to implement the task request without human intervention via an associated dental practice system GUI; deploy a system level model in response to an error encountered by the task level model; and execute the system level model to recover from the error.

In a further aspect, an AI platform implemented in a server is provided, comprising: a universal dental interface (UDI) configured to render and process records in a common format, wherein the records are obtained from disparate dental practice systems that have different graphical user interfaces (GUIs) and that store data in different formats; and a vision-enabled AI interface (VAI) system configured to receive a task request from the UDI, deploy a task level model selected from a plurality of task level models trained to perform the task request within an associated dental practice system, and utilize the task level model to implement a vision sensor unit (VSU) and a device controller unit (DCU) to perform the task request without human intervention via an associated dental practice system GUI.

In a further aspect, an AI method is provided that includes: receiving a user initiated request at a cloud server from a client device to obtain, process or save a dental record at a selected dental practice system selected from a plurality of disparate dental practice systems; processing the user-initiated request and generating a task process; selecting a task level model from a plurality of task level models and deploying the task level model to a remote dental practice server running the selected dental practice system; receiving a notification of either a completed task process or a failed task process from the task level model; and in response to the failed task process, deploying a system level model at the cloud server to recover from the failed task process, wherein recovering from the failed task process includes successfully autocorrecting the failed task process or requesting a user to manually correct the failed task process.

### BRIEF DESCRIPTION OF THE DRAWINGS

FIG. 1 depicts a dental collaboration cloud in accordance with embodiments.

FIG. 2 depicts a universal dental interface in accordance with embodiments.

FIG. 3 depicts elements of AI smart assistant platform in accordance with embodiments.

FIG. 4 depicts a high-level architectural diagram of an RPA system designed to perform software tasks using interface-level AI assistance, wherein user behavior is replicated through interactions with the graphical user interface (GUI), in accordance with embodiments.

FIG. 5 illustrates the delegation of operational responsibilities from an Application Controller to an Application Processing Unit, which interfaces with remote software systems by utilizing real-time video streams, screen captures, and control inputs facilitated via a Vision Sensor Unit (VSU) and Device Controller Unit (DCU), in accordance with embodiments.

FIG. 6 illustrates how the Vision Sensor Unit (VSU) captures screen imagery to detect graphical user interface (GUI) elements and operates in coordination with a Device Controller Unit (DCU) to generate mouse and keyboard control signals, thereby emulating user interaction with the interface in accordance with embodiments.

FIG. 7 depicts a matrix of AI models, according to embodiments.

FIGS. 8-10 depict interfaces a task processing system according to embodiments.

FIG. 11 depicts a flow chart of a process for implementing a AI smart assistant platform according to embodiments.

FIG. 12 depicts a flow chart of an enhanced processing service according to embodiments.

FIG. 13 depicts a network environment according to embodiments.

FIG. 14 depicts a computing system according to embodiments.

### DETAILED DESCRIPTION

This invention discloses a vision-enable artificial intelligence (AI) interface system designed to operate across software environments, including, but not limited to, those used in dental practices. The system is intended to augment human capability by assisting providers, clinicians, and support staff in the execution of routine, repetitive digital tasks. These tasks, while within the skillset of human users, typically consume time that could otherwise be more productively applied to cognitively demanding, judgment-intensive, or patient-centered activities. The system functions within supervised user sessions, employing conventional graphical user interfaces (GUIs) and input mechanisms (e.g., mouse, keyboard) to mimic human interaction, without requiring direct integration with application programming interfaces (APIs).

In existing systems, third party tools often access software in ways that may be inconsistent with the application’s terms of service as opposed to the proposed user-mirroring systems and methods, which operate within the same boundaries as a human user. The present approach provides a more adaptive and intelligent solution, i.e., one that can learn and replicate user behavior directly through the graphical user interface, like a trained human. Recent advances in artificial intelligence, computer vision, natural language processing, and control systems have made this possible, enabling software systems to operate at the interface level with unprecedented accuracy, flexibility, and speed.

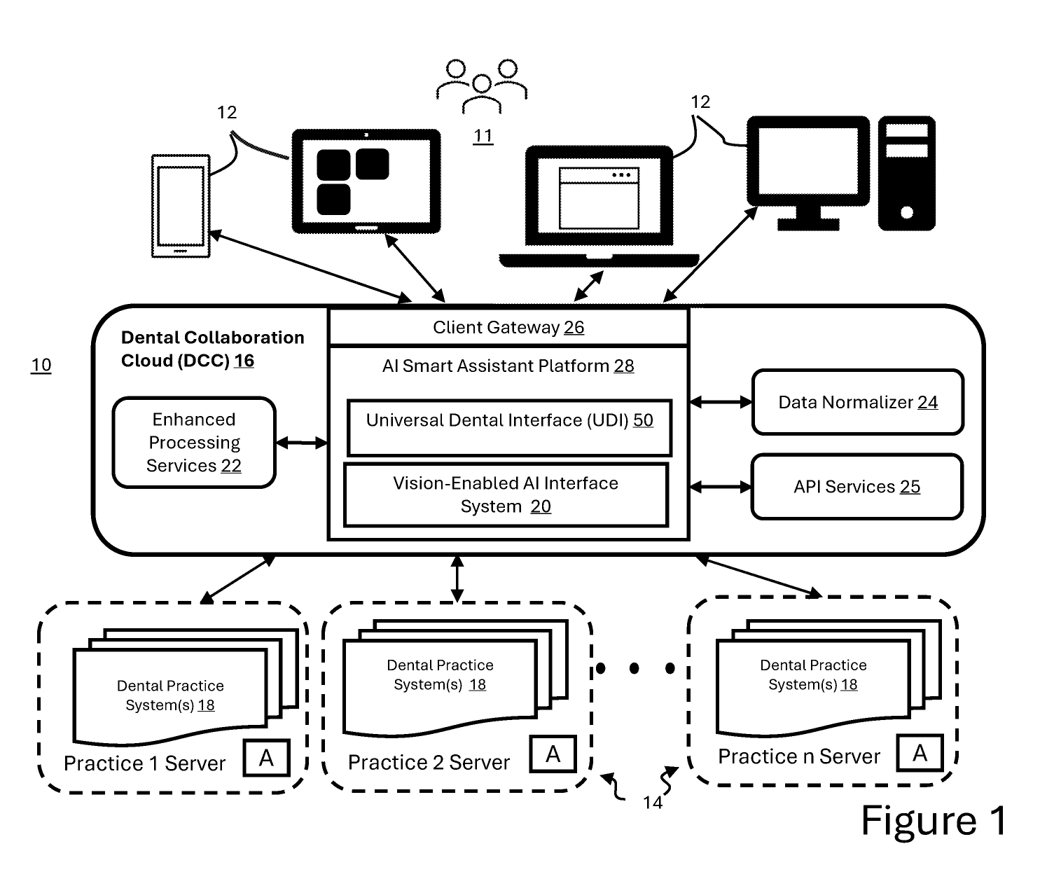

FIG. 1 depicts a system 10 having a dental collaboration cloud (DCC) 16 that allows users 11 to interact with (i.e., request, process, save) data and processes running on any number of disparate dental practice systems 18 (e.g., practice management systems, imaging systems, lab systems, etc.), running on any number of remote practice servers 14. As is understood in the dental domain, there exist numerous disparate dental practice systems 18 (e.g., practice management systems (PMSs), etc.) that have different graphical user interfaces (GUIs), workflows, etc., and store data in different formats. In this embodiment, users 11 can interface with any dental practice system 18 using a client device 12 to access DCC 16 via a client gateway 26. Note that while various embodiments describe system 10 as being implemented in a cloud environment, it is understood that DCC 16 and any reference to a cloud herein is intended to be interpreted as any type of server architecture.

In one illustrative embodiment, DCC 16 includes an AI smart assistant platform 28 that allows users 11 to interact with disparate dental practice systems 18 using a universal dental interface (UDI) 50. Users 11 may for example include dentists, other dental professionals, support staff, lab technicians, patients, etc. Further details of a DCC 16 and UDI 50 are for example disclosed in US patent application 19/348,014, DENTAL COLLABORATION CLOUD, filed on Oct. 2, 2025, and US patent application 19/172,846, ASYNCHRONOUS DATA SHARING COMPUTING INFRASTRUCTURE, filed on Apr. 8, 2025, which are hereby incorporated by reference.

In order to effectively interface with disparate dental practice systems 18, which typically have limited API capabilities, AI smart assistant platform 28 includes a vision-enable AI interface (VAI) system 20 tailored and trained on dental practice systems 18 to mimic human actions via dental practice system GUIs. VAI system 20 utilizes machine learning and the like (i.e., intelligent automation) to enable handling of complex interface environments involving different systems 18, different system versions, different operating system environments, error handling, and more. AI smart assistant platform 28 is able to process unstructured data, utilize pattern recognition, implement complex decision-making, etc. Unlike other RPA systems that target a particular application interface, the present VAI system 20 is designed and trained for an entire domain (e.g., dental practice) that uses disparate systems, but which share common attributes that can be exploited by machine learning.

AI smart assistant platform 28 is accordingly able to retrieve data from and store data to any dental practice system 18 using VAI system 20. Because data is stored and managed differently in different systems 18, a data normalizer 24 is provided that normalizes (i.e., converts) data in different formats to a universal or common format on the DCC 16. In addition, because the AI smart assistant platform 28 is able to pull data from many different sources, a set of enhanced processing services 22 are included that can integrate and process data from different sources using AI (and other techniques) to generate enriched outputs for users 11, which would otherwise not be available as an automated process.

Note that in certain embodiments, VAI system 20 is intended to augment the use of application programming interfaces (APIs) that are available in existing dental practice systems 18. Accordingly, in the depicted embodiment, AI smart assistant platform 28 includes a set of API services 25 that allows platform 28 to utilize available APIs where they make sense and provide value such as performance and reliability. Platform 28 can alternatively and/or selectively utilize VAI system 20 to minimize unnecessary dependency, complexity, and cost (including implementation and maintenance effort) where APIs are limited or operationally restrictive.

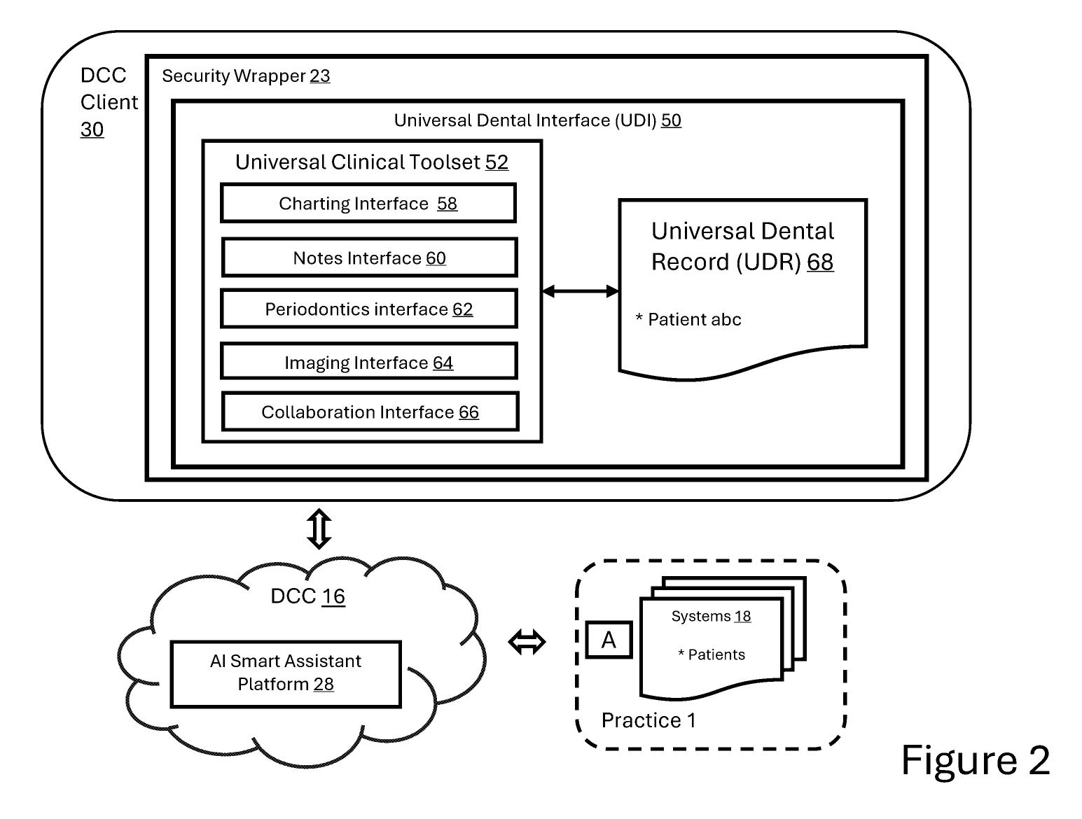

FIG. 2 depicts an illustrative embodiment of a DCC client 30 that renders a UDI instance configured to allow user interaction with patient data obtained from one or more systems 18 via the AI smart assistant platform 28 running on DCC 16. Each DCC client 30 includes a security wrapper 23 that ensures that the user has privileges to access respective patient information (e.g., based on private network rights, privilege levels, etc.). The security wrapper 23 is for example implemented and controlled by local security features and/or security services provided by DCC 16.

The DCC client 30 displays patient information within an instance of universal dental interface (UDI) 50, which is an agnostic platform for interactively displaying a universal dental record (UDR) 68 and other information for a selected patient. The universal dental record 68 is created by an adaptable integration framework within DCC 16 based on information from a respective system 18 and is temporally saved in DCC 16. Accordingly, regardless of the system 18 used by a given dental practice, the information will always be transformed and displayed in a standardized manner as an instance of UDI 50.

Within UDI 50 is universal clinical toolset 52, which not only provides standard interfaces such as a charting interface 58, a notes interface 60, a periodontics interface 62, and an imaging interface 64, but also provides a collaboration interface 66. Accordingly, when a user such as dentist within Practice 1 wishes to see a patent record via the DCC client 30, the dentist signs in and requests a patient record (e.g., via a search feature not shown). The request is passed to DCC 16, which in turn securely obtains the record from the dentist’s system 18 using RPS services. DCC 16 then transforms the record into a standardized UDR format and stores the processed record in a UDR data store. The patient’s UDR 68 is then uploaded to the UDI 50 on client 30, where the dentist can view, edit, and interact with the record 68. Any changes or updates to record 68 are returned back to DCC 16, which converts the changes back to the native format of the dentist’s system 18 and writes the changes thereto. Note that the update process can occur in real time, near real time, in batch mode, or at a later time. Accordingly, users can view and interact with patient records in a standardized matter, regardless of the client device or underlying practice management system utilized by the practice.

It is understood that DCC client 30 and/or UDI 50 may be implemented in any manner. For example, they may be implemented as virtual applications optimized to run in a virtual environment that can reside on the client device and/or in the cloud. In other cases, they may be implemented as web applications that run within a browser. Still in other cases, they may be implemented as native programs running on a device. Regardless of the implementation environment, the this approach enable comprehensive workflows that allow clinicians and staff to remain within a modern clinical toolset rather than constantly toggling between disparate legacy systems.

Furthermore, although described herein as being used in conjunction with UDI 50, platform 28 having VAI system 20 may be implemented with any type of interface to simplify the process of obtaining, processing and saving data to and from disparate dental practice systems 18. For example, rather than incorporating a comprehensive visual interface such as UDI 50, an interface that simply uses natural language inputs and outputs could instead be utilized, e.g., “email me the latest scan for patient x,” or “what time is my next appointment,” etc. In other cases, platform 28 may be implemented for a lightweight interface for a limited purpose, e.g., preparing, retrieving and submitting notes, which is a time consuming activity for practitioners. Such a lightweight interface may allow a practitioner to speak or type a passage such as “submit a note for patient y that says … .”

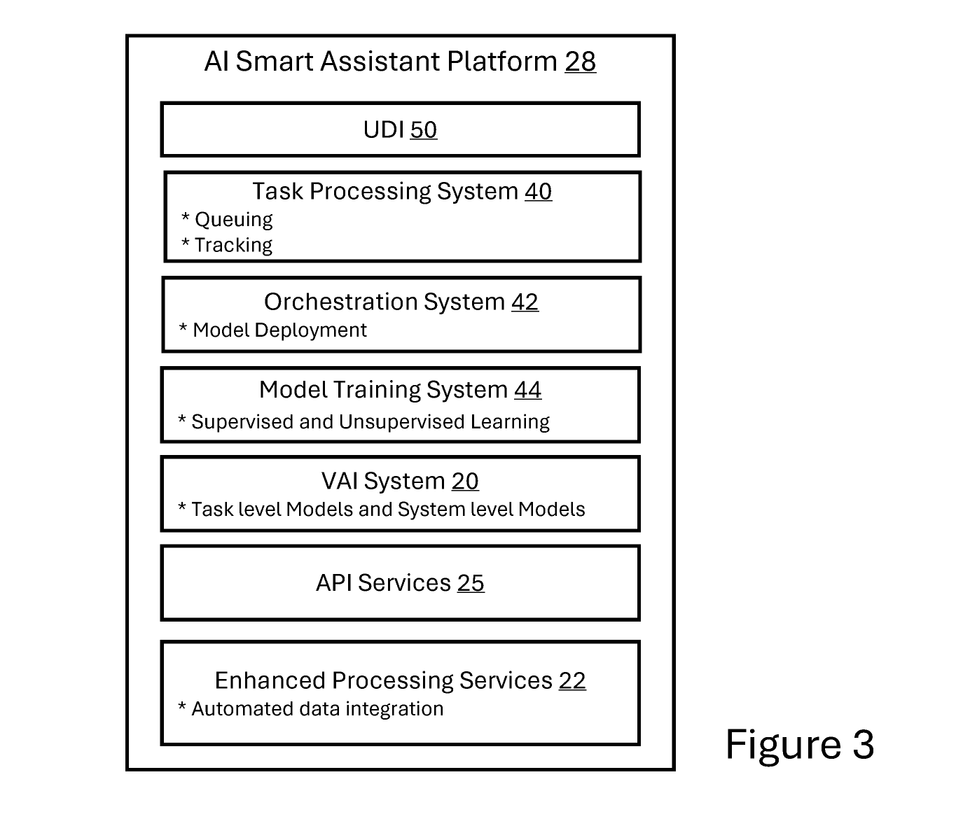

FIG. 3 depicts illustrative components of AI smart assistant platform 28, which generally includes: (1) a UDI 50 (or other interface); (2) a task processing system 40 that provides queuing and tracking of tasks initiated by users 11; (3) an orchestration system 42 that implements and deploys models for the VAI system 20; (4) a model training system 44 that uses supervised and unsupervised learning to train VAI system models; (5) VAI system 20 that provides an AI based automated interface for dental practice systems 18, and includes task level models and system level models; (6) API services 25 that leverages existing API interfaces to obtain and process data; and (7) enhanced processing services 22 that provide automated data processing and integration.

In various aspects, platform 28 provides: AI-driven GUI interaction, orchestration, and workflow execution across disparate dental systems 18; an adaptive/self-learning model infrastructure including visual correction, exception learning, workflow retraining, and self-healing automation; customer-authorized interaction and operation using existing user permission infrastructures; delegated/supervised AI assistance operating through exposed GUIs and standard user interfaces; a system that mirrors actions a legitimate authorized user could manually perform; a system that avoids backend intrusion, credential circumvention, protocol interception, or unauthorized system access; and both API-based integrations and interface-level integrations where APIs are unavailable, restricted, or not provided.

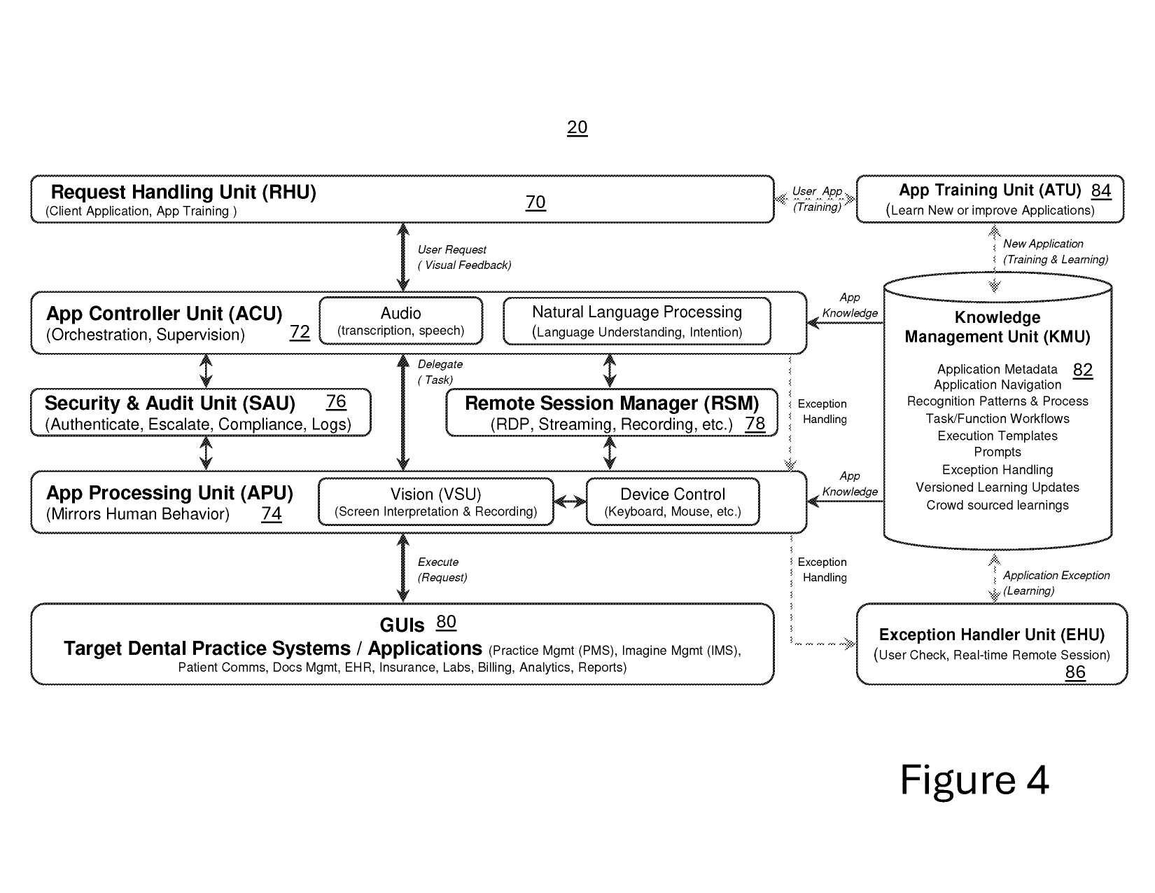

In the example shown in FIG. 1, each of the practice servers 14 may be instrumented with an agent A, that essentially acts as a local authorized user of a respective server 14 to perform some visional enabled functionality remotely from the DCC 16. FIGS. 4-6 depict a high-level architectural representation and various components of vision-enable AI interface (VAI) system 20 for interfacing with GUIs 80 of target dental practice systems and applications. As shown in FIG. 4, components for implementing these services include a Request Handling Unit (RHU) 70, that serves as the interface between user-initiated requests and system-level execution. It performs the following functions:

Accepts requests in multiple forms:
Verbal commands
User interface actions
Application-generated triggers

Forwards all valid requests to the Application Controller Unit (ACU) 72 for interpretation and delegation.

Provides feedback primarily through visual indicators within the graphical user interface (GUI), such as:
Highlighting
Progress indicators
State transitions

Minimizes audible or interruptive prompts, which are only used when clarification or error handling is necessary.

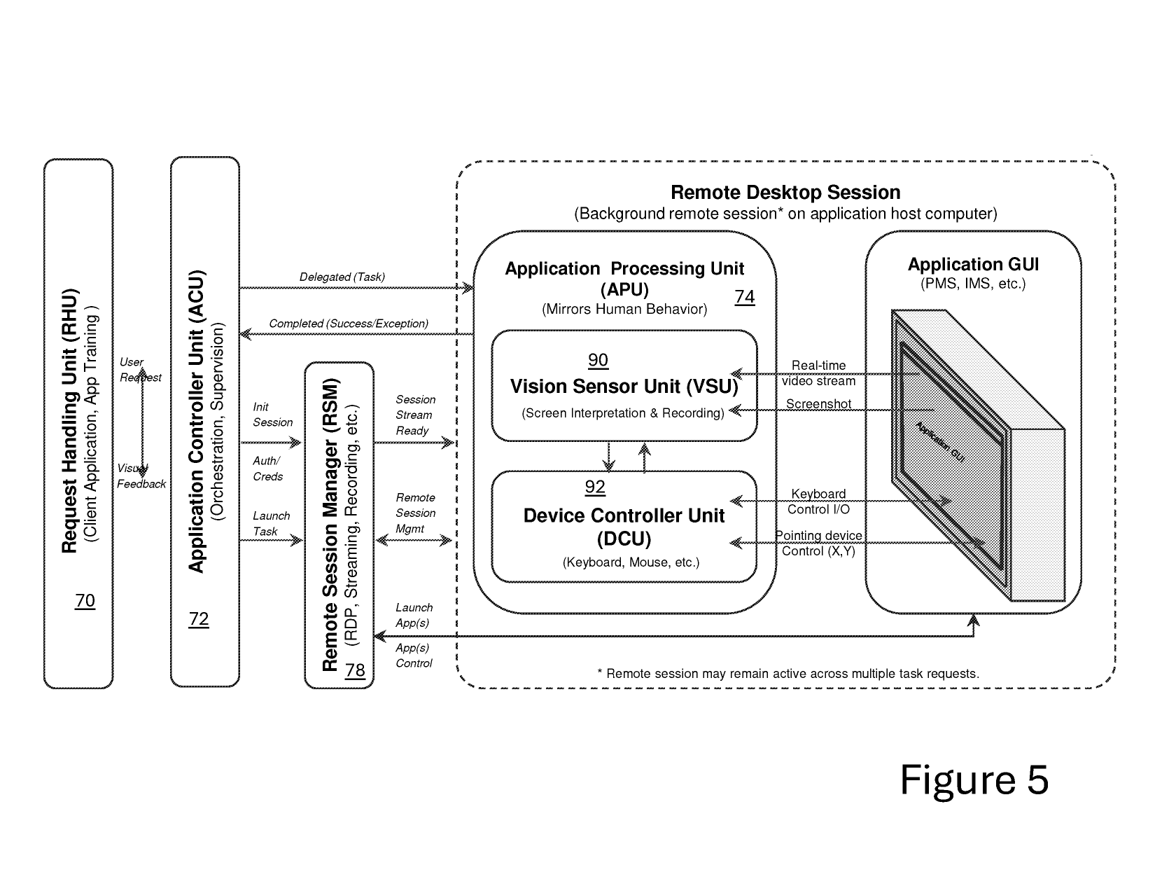

This design promotes smooth, uninterrupted clinical workflows while minimizing cognitive overhead for users during active sessions. The RHU 70 is the entry point to the system and is further detailed in FIG. 5.

The Application Controller Unit (ACU) 72 serves as the central orchestration hub, managing high-level logic, task routing, system state coordination, and remote session initiation. It receives structured and unstructured inputs from the RHU, including direct function calls, GUI interactions, and natural language commands—often transcribed or spoken. When natural language input is detected, the ACU invokes an NLP module to determine intent, extract parameters, and translate loosely defined requests into actionable task requests. This capability allows for flexible, user-friendly interaction modes without requiring rigid syntax or command structure.

The ACU 72 is also responsible for initiating and managing the remote session used by the application processing unit (APU) 74 to interact with target dental practice systems. It does so by:
Sending session initialization requests to the Remote Session Manager (RSM) 78
Handling authentication and credential management
Issuing launch and task execution instructions to the RSM 78

In its supervisory role, the ACU 72 monitors execution integrity, tracks operational context, and detects when intervention is required—either through exception routing to the exception handling unit (EHU) 86 or via retry/fallback logic. It ensures serial or parallel execution paths remain compliant with the user’s original request and workflow constraints. The ACU’s orchestration and supervision role, including interaction with the RSM and remote environments, is illustrated in FIGS. 4 and 5.

The APU 74 is responsible for simulating human behavior in task execution. Once it receives a task from the ACU 72, it coordinates with the Remote Session Manager (RSM) 78 to access the appropriate remote desktop session. Inside that session, the APU 74 leverages a Vision Sensor Unit (VSU) and a Device Controller Unit (DCU) to interpret screen content and perform interactive actions on the GUI of the target application 80.

The APU:
Listens for tasks from the ACU
Connects to the application GUI via the RSM
Uses the VSU to interpret current screen state
Uses the DCU to perform cursor movements, keyboard inputs, and clicks
Reports success or failure (with error code) to the ACU

The APU mirrors human interaction closely, mimicking the steps a user would take inside the remote environment, and is shown interacting within a persistent remote session in FIGS. 4 and 5.

The vision sensor unit VSU 90 is responsible for capturing and interpreting the graphical layout of an active interface. It serves as the system’s visual intelligence module and provides spatial and semantic understanding of GUI elements.

The VSU 90:
Captures real-time screen output via screenshot or video stream
Uses vision-based models to detect GUI components (e.g., buttons, input fields, tabs)
Maps screen coordinates and assigns identifiers to UI elements
Sends the interpreted layout to the APU to support interaction logic

To enable fast and consistent interpretation, the VSU 90 leverages pre-trained machine learning models developed during the application training phase. This allows most screens to be processed locally and with low latency, without relying on cloud inference. In the event the VSU encounters an unknown or ambiguous screen state, it can optionally invoke a fallback mechanism that utilizes cloud-based large language models (LLMs), such as ChatGPT-like systems, to interpret the scene and return guidance. This tiered design supports both high performance and robust exception handling.

Other visual interpretation techniques may also be integrated. The system is not limited to these methods, and hybrid or modular approaches can be employed based on deployment configuration.

The device control unit (DCU) 92 is responsible for simulating the physical actions a user would perform when interacting with a GUI. It receives positional and action data from the APU and executes those instructions using standard input control mechanisms.

The DCU 92:
Moves the cursor to specified screen coordinates
Executes mouse clicks, drags, or hover events
Simulates keyboard input for form fields or command sequences Sequences actions according to temporal rules and user behavior models It operates as a software-controlled agent that uses low-level operating system calls or virtual input drivers to issue commands that are indistinguishable from actual human input. The DCU 92 must ensure accurate timing and input fidelity, especially in latency-sensitive workflows such as clinical documentation or real-time image manipulation.

As shown in FIG. 5, the APU 74 may run locally at the practitioner server within the remote desktop session. Thus, models for performing task specific GUI interactions can be implemented with remote agents A that do not require cloud based interaction. If an error or exception is detected, other generalized system level models that run on the cloud can launched to address the error/exception.

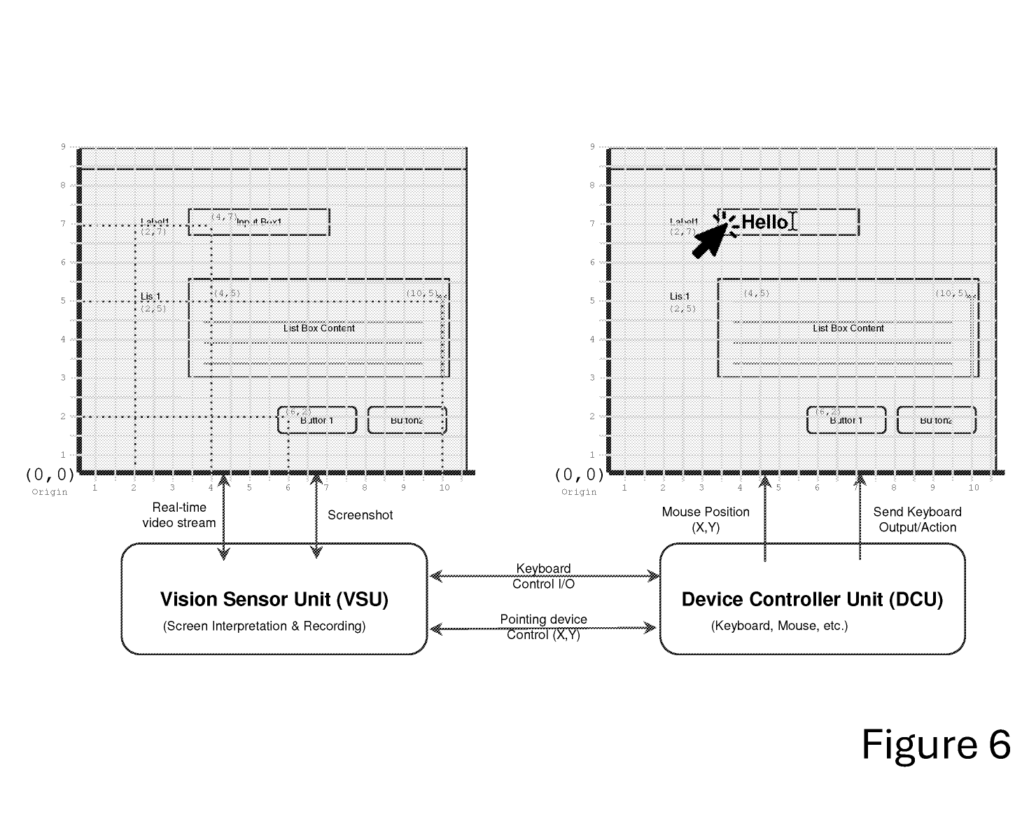

FIG. 6 illustrates a real-time coordination between the Vision Sensor Unit (VSU) and the Device Controller Unit (DCU) in executing GUI-level interactions. It presents a structured view of the screen as a grid of identifiable visual components with precise spatial references.

The VSU processes screen content into a labeled grid:
GUI elements such as buttons, input fields, and tabs are mapped with bounding boxes and assigned unique labels.
Each element is indexed by screen coordinates to support reproducibility of actions.
The grid format allows fast lookup by the APU, which sequences actions using these coordinates.

The DCU consumes this structured map and converts it into device-level control signals:
Cursor movements are mapped from the origin to the target element’s center point.
Clicks, drags, and keyboard inputs are sequenced based on element type and task step.
Visual markers or debug indicators may be briefly rendered to verify element targeting and alignment.

This coordination enables the system to:
Emulate human precision in navigating unfamiliar interfaces.
Avoid hardcoded pixel locations or fragile image matching.
Generalize across resolutions and display configurations. In multi-monitor or high-DPI environments, the system applies display normalization and resolution scaling to maintain interaction fidelity.

This grid-based abstraction also supports:
Replaying past sessions from logs.
Transferring workflows across machines.
Integrating fallback logic for low-confidence detections.

FIG. 6 also depicts the interplay between the VSU’s screen interpretation and the DCU’s control execution pipeline, forming the foundation for precise, resilient, and observable automation.

The VSU and DCU synchronize their operations based on a shared screen grid model. It provides both specific label-based matching (preferred when trained via the KMU) and general fallback matching (when no precise label is available). This hybrid approach enables flexible, resilient interaction with both known and unfamiliar software interfaces.

The Knowledge Management Unit (KMU) 82 serves as the central repository for application-specific knowledge, interaction patterns, task definitions, and learned behavior models, including task level models and system level models. It enables intelligent decision-making across multiple components by maintaining up-to-date context and execution history.

The KMU 82 supports four main domains:

1. Application Intelligence
Captures and stores application metadata, including screen layouts, UI element hierarchies, and control properties
Maintains navigation patterns and workflow paths to guide interface logic
Tracks and updates recognition patterns (visual, linguistic, behavioral) used for interpreting context and triggering actions .

2. Workflow and Task Logic
Defines clinical and operational workflows as step-by-step procedures
Houses execution templates: modular, reusable task components with parameterization
Manages task function routing, decision trees, and validation logic

3. Interaction Management
Handles prompt formats, expected response structures, and override logic for AI interaction
Incorporates exception handling strategies and logs, including escalation conditions and resolution histories .

4. Learning and Adaptation
Maintains versioned learning updates, supporting rollback, A/B testing, and regulatory traceability
Integrates crowdsourced learnings and behavioral feedback from system-wide and local deployments

The KMU acts as a shared resource accessed by the following system components:
ACU (Action Control Unit): Retrieves workflow templates and logic routing data
APU (Action Planning Unit): Determines next actions and validates task context using KMU data
ATU (AI Training Unit): Feeds training updates and parameter adjustments into the KMU
EHU (Exception Handling Unit): Logs corrections and resolution patterns into the KMU for future reference

By consolidating and organizing this knowledge, the KMU enables consistency, adaptability, and generalization across workflows and deployment environments.

A System Learning Cycle governs how adaptive intelligence is cultivated and distributed across the system. It captures behavioral data, human overrides, system feedback, and exception resolutions to continuously improve execution reliability, learning accuracy, and personalization.

### Learning Flow:

1. Observation
All operational events, including user activity, system performance, and error events, are captured and logged in a learning ledger.
These include task outcomes, timing patterns, user overrides, exception triggers, and contextual data points.

2. Analysis and Interpretation
Captured data is periodically analyzed to identify trends, anomalies, and optimization opportunities.
High-value learning signals include repeated exception paths, alternate resolution patterns, or highly efficient workflows.

3. Learning Input and Rule Refinement
Updates are prepared for integration into the KMU.
These include:
Enhanced workflow templates or task sequencing logic
Updated recognition and classification models (e.g., for visual or language inputs)
Improved prompt-response mappings or timing configurations
Preemptive exception handling heuristics .

4. Validation and Simulation
Changes undergo automated and human-in-the-loop testing using realistic application sessions and simulated edge cases.
Regulatory and operational safety requirements are verified prior to any live deployment.

5. Deployment and Versioning
Refined models and templates are versioned and pushed to operational environments.
The KMU tracks each deployment’s lineage, enabling rollback, comparison, and compliance tracing.

6. Closed Feedback Loop
Once deployed, changes are re-evaluated in real-world scenarios.
Measured outcomes inform the next cycle, ensuring progressive learning without regressions.

Component Contributions:
ATU (App Training Unit): Contributes training insights and new application patterns.
EHU (Exception Handler Unit): Logs resolved exceptions, user-corrected actions, and supervisor guidance.
APU/ACU: Provide timing metrics, task success/failure patterns, and alternate paths.
SAU (Security & Audit Unit): Ensures all learning activity is logged, traceable, and compliant.

This continuous loop reinforces system robustness, adaptability, and user alignment—while protecting safety, accuracy, and auditability.

The App Training Unit (ATU) 84 is responsible for teaching the system how to operate new or unfamiliar software applications. It enables the smart assistant to observe, interpret, and reproduce user behavior across varied interfaces—without requiring code changes or API integrations. All outputs from the ATU populate the Knowledge Management Unit (KMU), ensuring consistent task execution and rapid scalability across workflows.

The ATU supports at least two complementary approaches to training: .
1.Development Mode (Manual Teaching)
Expert users or trainers define workflows programmatically or through configuration. They specify navigation sequences, task logic, and UI element labels. This is useful for known applications with well-defined structures.

Interactive Learning Mode (Guided Training)
The assistant guides the user through an interactive, ChatGPT-like session using natural voice or text. It prompts the user to:
Launch the application
Log in (while capturing credential structure for secure storage in the Security & Audit Unit)
Walk through the main menu and high-level navigation
Explain functional areas such as Charting, Digital Imaging, and Clinical Notes
Demonstrate tasks (e.g., searching for a patient, opening a chart, adding treatment)

3. As the user navigates and explains, the assistant:
Captures screens, interactions, and transitions
Labels key UI elements and behaviors
Builds reusable task templates
Identifies unexplained areas and asks follow-up questions

4. This mode mimics how a human assistant would learn—by observing, asking, and performing. It can be voice-interactive and operates in real time, updating its internal knowledge as it goes.

Core Capabilities include:
Workflow Acquisition: Learns tasks by watching real user behavior
Template Generation: Converts observed actions into structured, parameterized task templates
Semantic Labeling: Tags UI elements based on usage, position, and visual cues
Training Replay: Supports review and annotation of recorded sessions
Confidence Scoring: Flags areas for clarification or human review Integration Points
KMU: Stores all learned templates, task flows, and UI maps
APU: Executes tasks based on ATU-generated templates
EHU: Triggers re-training if execution fails or logic becomes outdated
ACU: Invokes ATU when onboarding new applications or workflows

The system can operate in advanced voice mode, similar to ChatGPT’s real-time interactive dialog, and adjusts its questions based on visual feedback from the interface.

The Exception Handler Unit (EHU) 86 manages real-time exception resolution, enabling the system to recover gracefully from errors and improve through user-supervised learning. It activates when the system encounters a task it cannot complete due to unfamiliar conditions, missing information, or unforeseen changes.

The EHU operates similarly to the App Training Unit (ATU), except it is triggered during execution. It allows the user who initiated the task to step in, guide the assistant, and optionally teach it how to resolve the issue in the future.

Core Functions
Exception Notification: Notifies the user when a task fails or stalls, prompting for input or assistance.
Crowdsourced Learning: If the user resolves the issue, the assistant asks whether to remember the fix. The resolution can be saved for:
Just the current user
All users at the site
All users across sites (pending admin approval)
Supervised Resolution: For unfamiliar issues, replays the failed task,
initiates a guided session, and observes the user as they complete the task.
Template Generation: Captures and stores the corrective steps in the KMU as versioned templates.
Escalation and Audit: Logs unresolved failures and escalates them as needed.

The system accordingly detects a failed task, prompts the user for guidance, captures a successful resolution, and offers to retain that fix for future use with user-defined scope.

The Security & Audit Unit (SAU) 76 safeguards sensitive information, enforces access controls, and ensures traceability throughout the system. It is responsible for securing stored credentials, validating user identity, and maintaining a detailed audit trail of all operations. This unit plays a central role in regulatory compliance and system integrity.

Core Functions
Credential Management: Securely stores, retrieves, and updates credential structures used during automated or assisted workflows. Credentials are encrypted and compartmentalized by user, role, and environment.
Access Control Enforcement: Validates user permissions before allowing access to sensitive actions or data. Supports multi-factor authentication and integrates with existing identity systems.
Audit Logging: Captures detailed logs of all user actions, system decisions, prompts, and overrides. Each log entry includes timestamps, user/session identifiers, task IDs, and outcome data.
Policy Compliance Monitoring: Monitors operations for compliance with regulatory and organizational policies (e.g., HIPAA, GDPR). Detects deviations or unauthorized behavior in real time and raises alerts.
Delegated Authority Tracking: Logs any time a user delegates access or authority to another entity or automation. Ensures full visibility into who performed what actions and under what authority.
Session Integrity Monitoring: Verifies that remote or automated sessions behave within their authorized scope. Any deviation or suspicious behavior results in session termination and audit flagging.

The SAU operates as a foundational layer that intersects with every component in the system—ensuring trust, accountability, and operational transparency.

The Remote Session Manager (RSM) 78 coordinates the launch, authentication, and control of remote software environments. It provides the underlying infrastructure that allows the assistant to operate within external systems as if it were a local user—typically through virtual desktop or screen-sharing technology. The RSM ensures that the session is securely established, sustained, and terminated according to task requirements and compliance policies.

Core Functions
Session Launch and Teardown: Initiates and terminates remote sessions based on requests from the Application Controller Unit (ACU). Supports on-demand or persistent sessions.
Authentication Handling: Applies saved credentials via the Security & Audit Unit (SAU) or prompts the user if necessary. Verifies successful login and initial UI readiness.
Environment Verification: Confirms the application state, resolution settings, and screen integrity before allowing automation to proceed.
Session Monitoring: Continuously checks session health, connectivity, and activity. Restarts or escalates upon failure.
Secure Channel Management: Manages encryption, token handoffs, and isolation of each session. Prevents unauthorized access and enforces strict input/output containment.
Multi-Session Coordination: Supports concurrent sessions across systems or users, allocating compute and bandwidth resources dynamically.
Session Persistence: Remote sessions may remain active across multiple sequential tasks, minimizing overhead and improving responsiveness (see FIG. 2).

FIG. 5 illustrates the RSM’s central role as the bridge between the ACU and the remote environment:

The ACU issues:
Init Session to start a remote connection
Auth / Creds to authenticate the session securely (often from SAU)
Launch Task to trigger a specific function

The RSM manages:
Session Stream Ready acknowledgment back to the ACU
Remote Session Mgmt to maintain session health
Launch App(s) and App(s) Control to initialize and prepare software for interaction
Within the remote desktop session, the APU activates the VSU and DCU, allowing GUI-level execution via screen interpretation and input simulation.

These flows enable seamless, secure, and transparent control of external applications, even in constrained or legacy environments.

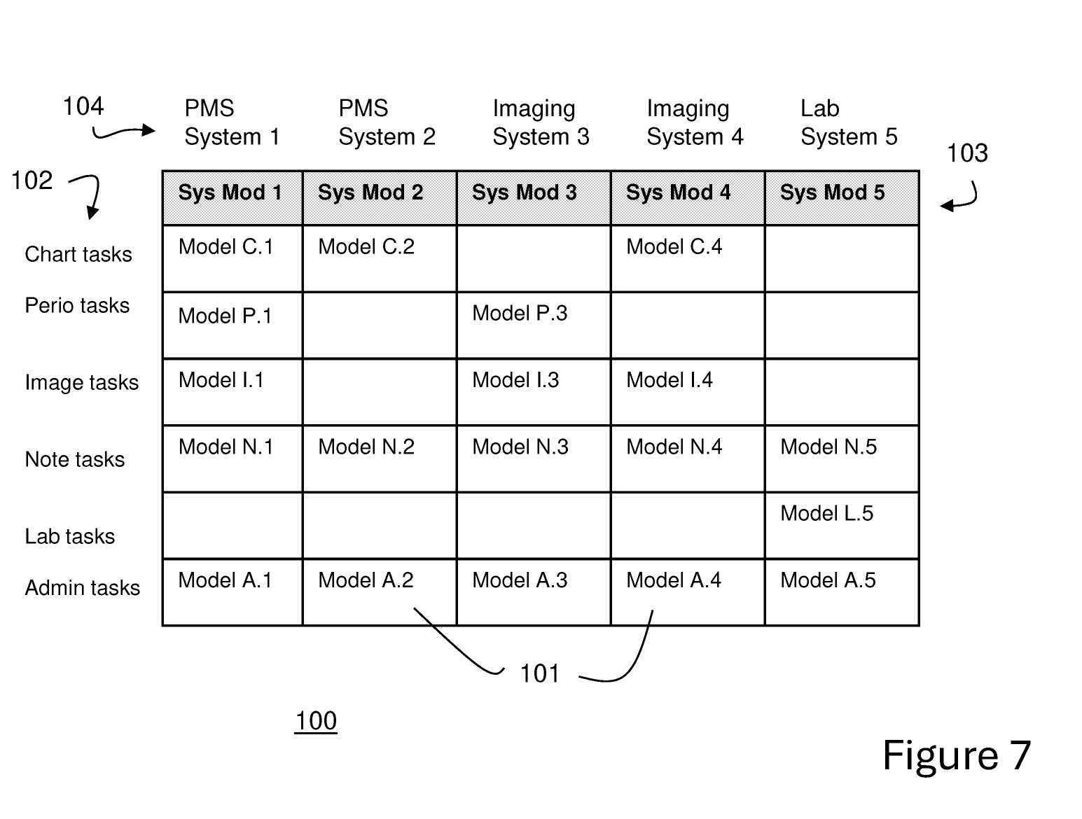

FIG. 7 depicts a simplified orchestration matrix 100 that includes a collection of AI task level models 101 and system level models 103 deployable by the orchestration system 42 and used by VAI system 20. On the vertical axis there is list of task categories 102, i.e., charting related tasks, periodontic related tasks, imaging related tasks, note related tasks, lab related tasks, and admin related tasks. On the horizontal axis are a set of illustrative dental practice systems 104. Within the matrix are a collection of task level models 101 (e.g., Model. C.1) configured to perform a given task 102 on a given system 104 (e.g., a charting task on PMS System 1). An orchestration system 42 (FIG. 3) maintains and deploys models when users submit process requests to the AI smart assistant platform 28. Each task level model 101 for example includes a workflow, GUI interactions, and AI capabilities to complete a task process on a disparate system 18. It is understood that the number of categories and task level models 101 may vary in number and scope and what is shown is for illustrative purposes only. For example, different versions of each dental practice system 104 may require separate task level models 101. Further, each task with a task category 102 may include a separate model (e.g., sign a note, amend a note, view a note, etc.).

In addition to the task-level models 101, matrix 100 also shows a set of system level models (e.g., Sys Mod 1, Sys Mod 2, …) 103. Each system level model 103 provides a fallback or recovery model for handling issues, such as errors raised as exceptions, etc., that occur when running a task level model on a given system. For example, Sys Mod 2 may be implemented to handle exceptions that occur when task level models C.2, N.2 or A.2 are running on PMS system 2. Other types of system level models may likewise be implemented, e.g., system level models for each of the different task categories, for different operating systems, for different software versions, etc. Furthermore, a single domain level model may be implemented to provide back-up support for an entire domain, e.g., dentistry, medical, etc.

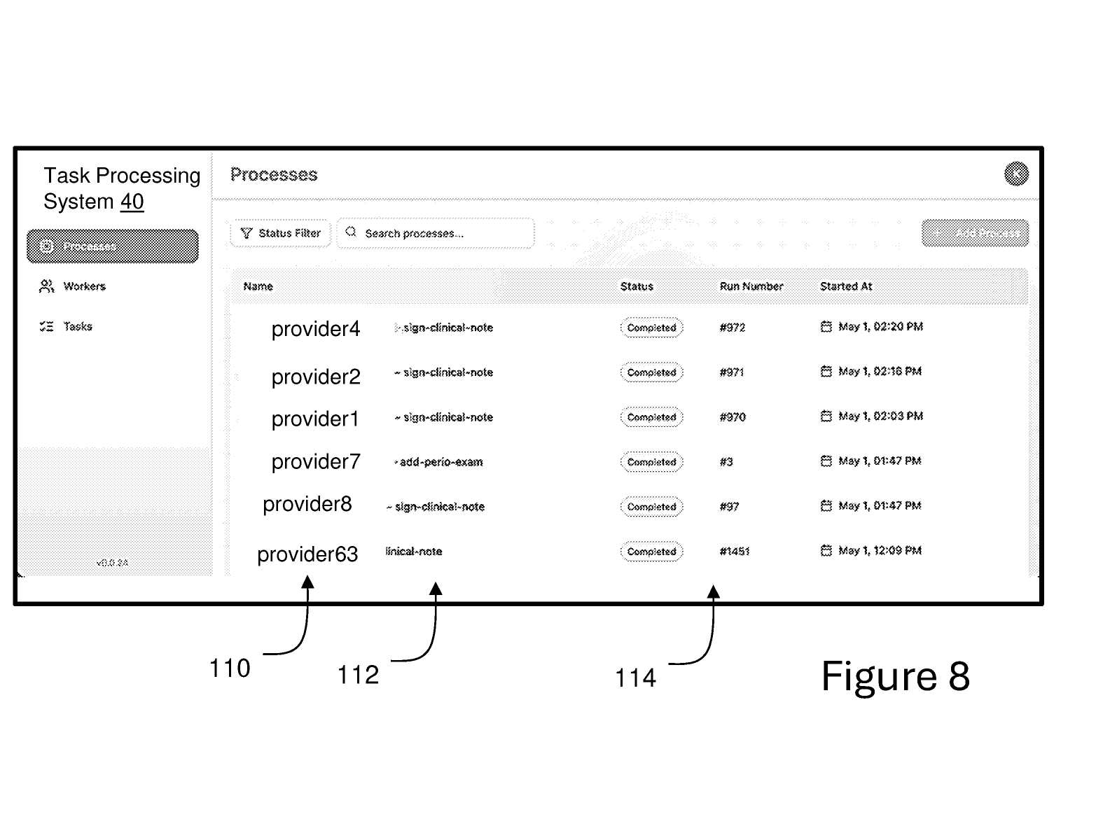

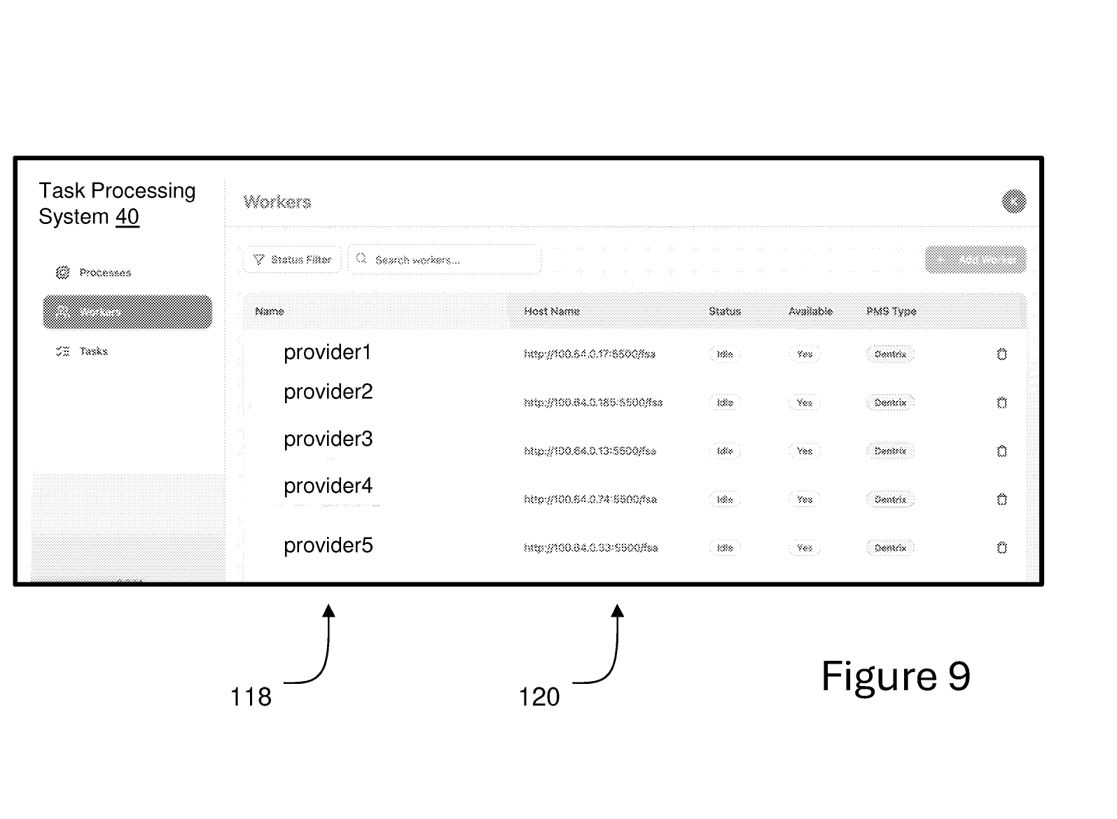

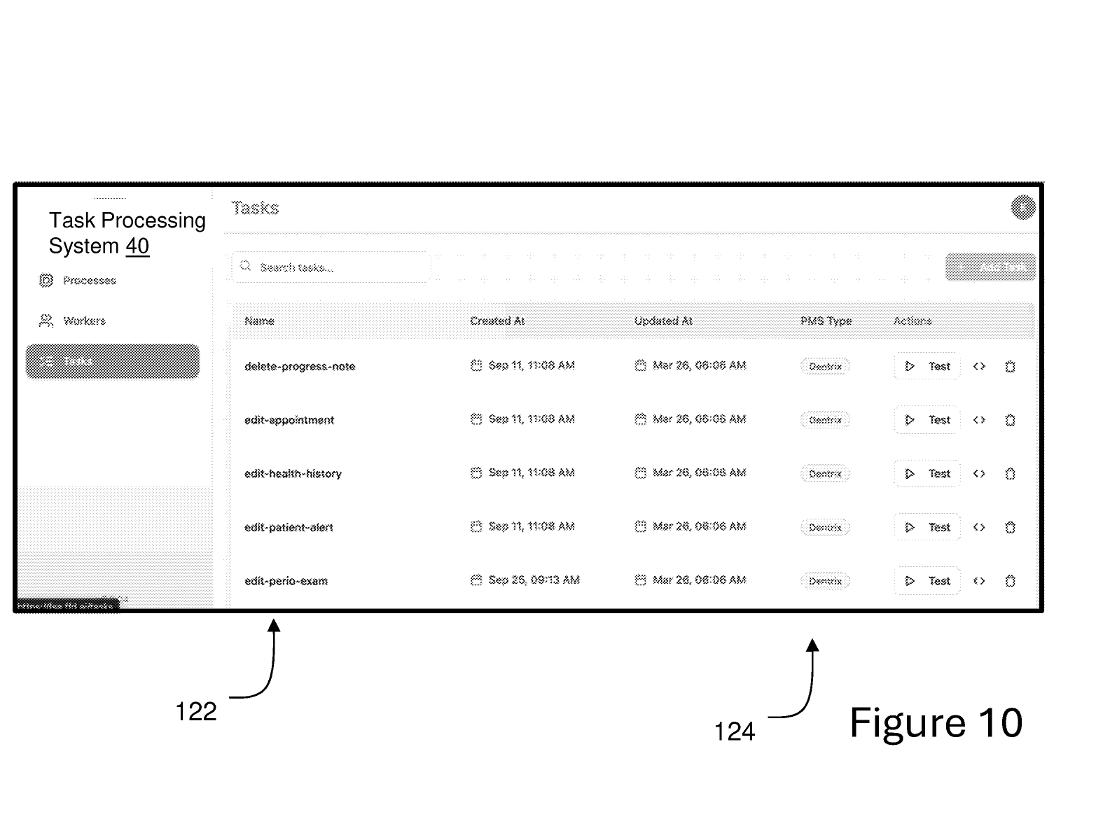

FIGS. 8-10 depict internal operational GUIs of task processing system 40 (see also FIG. 3). As noted, AI smart assistant platform 28 is configured to be utilized by any number of users, associated with any number of dental practices or the like. FIG. 8 depicts a first interface that shows a queue of requested processes received from various users/practices (i.e., providers or workers) 110. Each requested process includes a task 112, e.g., sign-clinical-note, add-perio-exam, etc., as well as status information 114. AI smart assistant platform 28 accordingly deploys executes each requested process 112 until the process is completed or fails. FIG. 9 depicts a second interface that shows all of the users/practices (i.e., workers or providers) 118 registered within the platform 28. This interface also shows server and dental practice system details 120 (e.g., host name, status, PMS type, etc.). FIG. 10 list all of the available tasks 122 for a give dental practice system 124. Each task 122 has an associated task level model (i.e., that implements a workflow, visual details, etc.) to allow VAI system 20 to intelligently interact with a GUI.

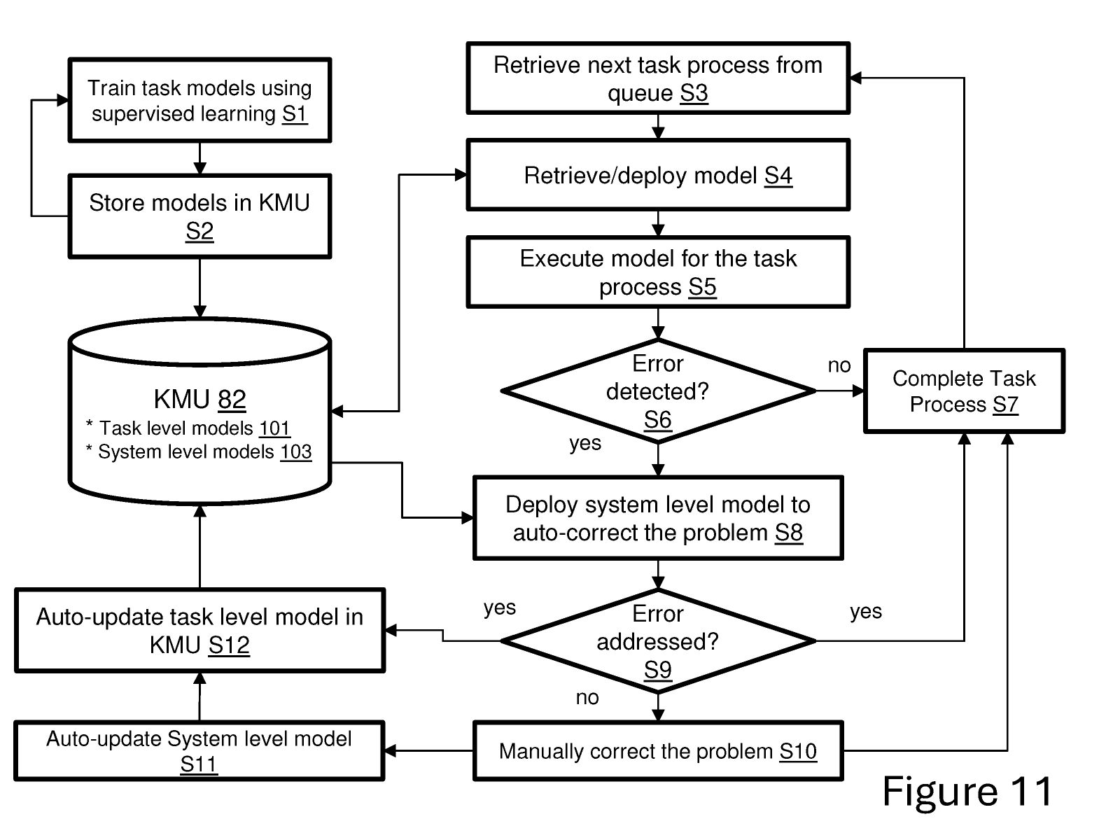

FIG. 11 depicts a flow diagram of an illustrative process implemented by AI smart assistant platform 28. Initially, at S1, task level models 101 are trained using supervised learning, e.g., as described herein, and at S2, models are stored in the knowledge management unit (KMU) 82. These steps S1, S2 are repeated as new tasks are implemented, updated, etc. One or more system level models 103 may likewise be trained at this stage.

At S3, a next task process is retrieved from the queue, as shown in FIG. 8, which may for example occur at a cloud server. At S4, an associated task level model 101 is retrieved from KMU 82 to execute the process and deployed from the cloud 16 to a remote practice server 14 (e.g., as an agentic AI), and at S5 the task level model is executed at the remote 14 server to implement the process. The task level model 101 provides a workflow, GUI-level interoperability and operational intelligence to perform the task process within the same boundaries as a human user. Each task level model may include a lightweight agentic AI that, e.g., adapts to different environmental situations that occur in the workflow. For example, rather than look for a particular data entry field at a particular location on a screen, the AI process can use a visual AI agent to evaluate the screen to locate the field. If the AI process encounters an issue it cannot resolve, an exception indicating some type of error can be raised. At S6, a determination is made whether an error is detected that cannot be addressed by the task level model 101, e.g., an unintended pop-up appears, an input field cannot be located, a label is not recognized, a workflow is wrong, etc. Such an error may include anything that is outside the capabilities of the task level model. If no error is detected, the task process is completed at S7, which may include a notification back to the cloud server that the task process was successfully completed, and a next task process is retrieved at S3. Note that while this example shows the operation as a single thread, it is understood that multiple threads may execute in parallel.

If an error is detected at S6, a notification of a failed task process may be returned to the cloud server. A system level model 103 is retrieved from KMU 82 and deployed at S8 to autocorrect or recover from the problem. For example, if an input field cannot be located or a label is not recognized, system level model 103 can analyze the error and attempt to autocorrect it. For instance, the model may be looking for a field in the upper right portion of the screen that says, “Enter Patient Name,” which is not present. The system level model can be deployed to evaluate the screen, and for example may find a field in the upper left portion of the screen that says “Enter Client Name.” Using a trained LLM or the like, the system level model may determine that Client Name is equivalent to Patient Name to address the problem. In another case, an unknown pop-up screen may be covering an input field required by the task level model 101. In this situation, the system level model may be called upon to analyze the pop-up window, determine it is not relevant, and instruct the task level model to click the x to remove it.

If the error is addressed at S9 by the system level model 103, the task process is completed at S7. In addition, the task level model may be auto-updated/retrained at S12 using an adaptive process, e.g., to recognize “Client Name” as a proper input field in the future. If the error cannot be addressed at S9, e.g., the system level model 103 cannot determine a solution for the error with a high level of confidence, the problem can be manually corrected at S10. For example, the workflow screen order to perform a task process may have changed, or the software returns an unknown operating system error condition. In this case, the system level model may instruct the user to manually perform the task process. As the user manually performs the process, the actions taken can be captured by a training system to auto-update/retrain the system level model 103 at S11. Accordingly, e.g., in the future when the same operating system error condition occurs, the system level model 103 should be able to address the issue using the same method as the user did. In addition, the task level model 101 can also be updated/retrained at S12, e.g., to utilize a corrected workflow. The updated/retrained models are stored back in the KMU 82. In some embodiments, this tiered approach has the system level model 103 running at the cloud, as opposed to task level models that run remotely at the practice server. This approach accordingly implements an adaptive/self-learning system including visual correction, exception learning, workflow retraining, and self-healing automation.

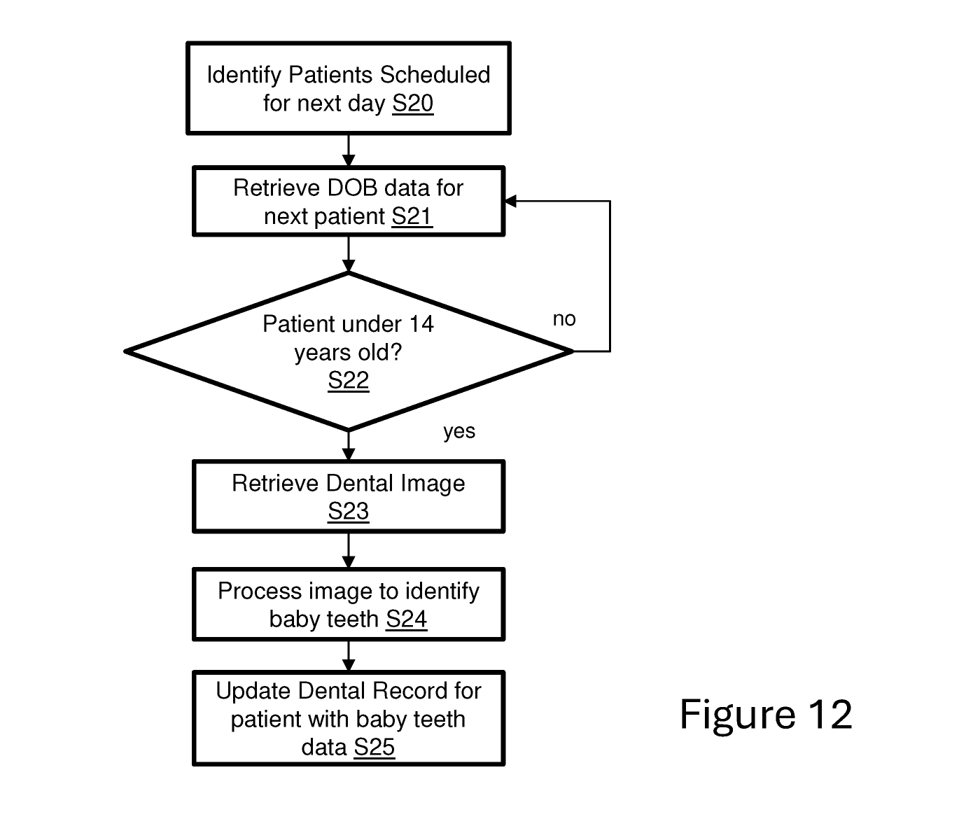

FIG. 12 depicts an illustrative enhanced processing service 22 (FIG. 3) performed by AI smart assistant platform 28. In this example, the platform 28 provides enhanced intelligence gathering for patients scheduled for a next day for a given practice. At S20, a PMS associated with the practice is interrogated with the VAI system 20 to identify patients scheduled for the next day, and at S21 date of birth (DOB) information is obtained for each scheduled patient. At S22 a determination is made whether a patient is under 14 years old (i.e., indicating that the patient may still have baby teeth, which may not be evident from the patient chart). At S23, if the patient is under 14 years old, a dental image (e.g., a screen shot) of the patient from the PMS or associated image system is retrieved and at S24 the image is processed to identify baby teeth using machine learning. Next, at S25, the dental record for the patient can be updated to mark which teeth are still baby teeth.

The following real-world scenarios further demonstrate how the platform 28 operates across typical dental workflows and automation tasks. Each scenario reflects an end-to-end interaction involving multiple system components.

1. Charting a Treatment Plan in a Legacy Dental Application
A clinician says: “Add a composite restoration for tooth number 14.”
The Request Handling Unit (RHU) captures the voice input and passes it to the Application Controller Unit (ACU).
The ACU parses intent, extracts task details, and routes execution to the Application Processing Unit (APU).
The APU activates a live session via the Remote Session Manager (RSM), launching the legacy dental app.
The Vision Sensor Unit (VSU) identifies the appropriate charting screen.
The Device Controller Unit (DCU) simulates user input to locate the tooth, open treatment options, and select “composite restoration.”
The Knowledge Management Unit (KMU) provides a validated task template for consistency.
The Security & Audit Unit (SAU) logs the action and stores audit data.
If the charting screen layout differs from expectations, the Exception Handler Unit (EHU) prompts the user to assist with resolution and offers to retain the fix.

2. Resetting a Forgotten Password
A front-desk staff member says: “Reset password for my account.”
The ACU identifies the intent and routes execution to the APU.
The APU opens user settings and initiates a password reset sequence.
During the process, a previously unseen two-factor challenge appears.
The Exception Handler Unit (EHU) activates, plays back what occurred, and prompts:
“I encountered a new verification step. Please guide me through the resolution.”
The user manually completes the steps.
The EHU prompts: “Should I remember this for future use?” and offers retention scope:
“Only for me,” “Other users at this location,” or “All users across all locations.”
If a broader scope is chosen, the request is sent for practice manager approval.
The KMU stores the fix as an exception-handling template once approved.

3. Training on a New Application
An admin launches training mode via the Application Training Unit (ATU).
The assistant prompts: “Please launch the application.”
After login, it continues: “Show me the main menu and navigation structure.”
As the user navigates, the ATU captures section layouts and prompts:
“What is the purpose of this section?” or “Which functions are available here?”
The user demonstrates tasks like patient search, chart access, and entering treatment.
The ATU records all labeled actions and workflows.
Templates are created and stored in the KMU.
Final prompt: “Training complete. Would you like me to try a task now?”

These scenarios illustrate how the assistant performs operational tasks, learns from supervision, resolves exceptions interactively, and improves with continued use.

As noted, the features of the present disclosure may for example be utilized with systems and methods described in US patent application 19/172,846 filed on 04/08/2025 entitled, ASYNCHRONOUS DATA SHARING COMPUTING INFRASTRUCTURE; and US patent application 63/704,821, filed on 10/08/2024, entitled DENTAL COLLABORATION CLOUD, the contents of which are hereby incorporated by reference.

Although described herein with respect to a dental domain, it is understood that the AI smart assistant platform could be used in other domains including, but not limited to, healthcare, enterprise software, and other settings where software workflows are carried out by human operators. Furthermore, as noted, a system or method may be provided that uses a hybrid API/VAI approach. In such a situation, platform 28 will evaluate a task request to determine if an API can be used to address the request. If an API cannot be used, then a VAI process is used, i.e., a task level model is deployed and executed.

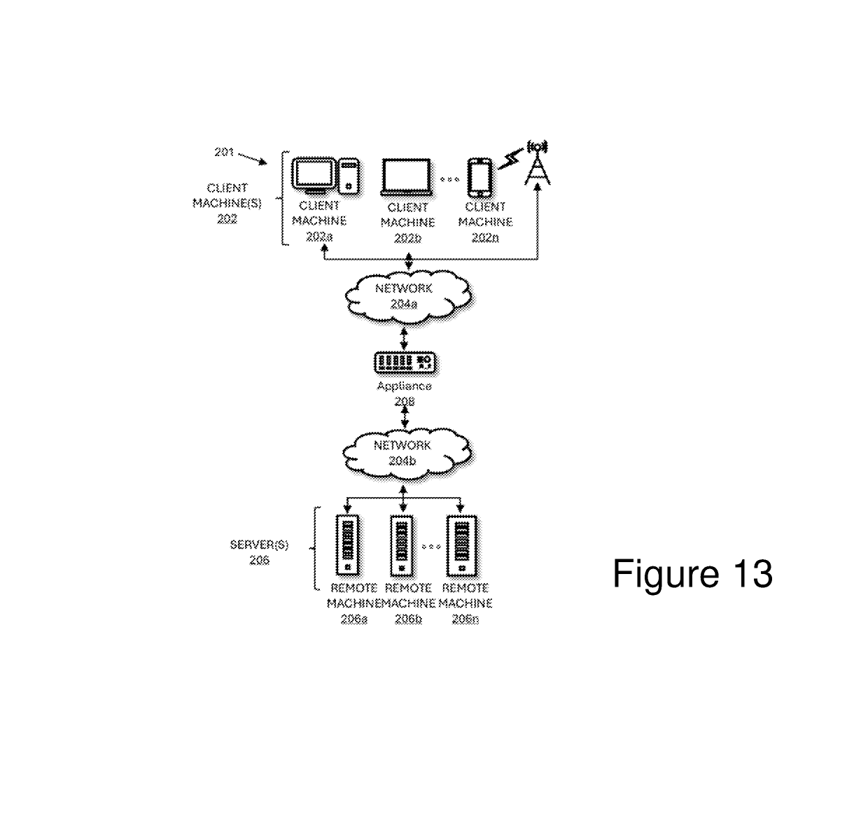

It is understood that aspects of the described platform can be implemented in any manner, e.g., as a stand-alone system, a distributed system, within a network environment, etc. Referring to FIG. 13, a non-limiting network environment 201 in which various aspects of the disclosure may be implemented includes one or more client machines 202A-202N, one or more remote machines 206A-206N, one or more networks 204, 204’, and one or more appliances 108 installed within the computing environment 201. The client machines 202A-202N communicate with the remote machines 206A-206N via the networks 204, 204’.

In some embodiments, the client machines 202A-202N communicate with the remote machines 206A-206N via an intermediary appliance 208. The illustrated appliance 208 is positioned between the networks 204, 204’ and may also be referred to as a network interface or gateway. In some embodiments, the appliance 208 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 208 may be used, and the appliance(s) 208 may be deployed as part of the network 204 and/or 204’.

The client machines 202A-202N may be generally referred to as client machines 202, local machines 202, clients 202, client nodes 202, client computers 202, client devices 202, computing devices 202, endpoints 202, or endpoint nodes 202. The remote machines 206A-206N may be generally referred to as servers 206 or a server farm 206. In some embodiments, a client device 202 may have the capacity to function as both a client node seeking access to resources provided by a server 206 and as a server 206 providing access to hosted resources for other client devices 202A-202N. The networks 204, 204’ may be generally referred to as a network 204. The networks 204 may be configured in any combination of wired and wireless networks.

A server 206 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 206 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 206 may execute a remote presentation services program or other program that uses a thin-client or a remote-display protocol to capture display output generated by an application executing on a server 206 and transmit the application display output to a client device 202. In other embodiments, server 206 may deploy an agent (i.e., a task level model) that includes logic as described herein to autonomously and proactively perform tasks, including performing complex, multi-step actions, learning and adapting, and making decisions independently. The agent may be equipped with short term, long term, consensus, and/or episodic memory. Short term memory for immediate interactions, long-term memory for historical data and conversations, episodic memory for past interactions, and consensus memory for shared information among agents. The agent can maintain context, learn from experiences, and improve performance by recalling past interactions and adapting to new situations.

In yet other embodiments, a server 206 may execute a virtual machine providing, to a user of a client device 202, access to a computing environment. The client device 202 may be a virtual machine. The virtual machine may be managed by, for example, a hypervisor, a virtual machine manager (VMM), or any other hardware virtualization technique within the server 206.

In some embodiments, the network 204 may be: a local-area network (LAN); a metropolitan area network (MAN); a wide area network (WAN); a primary public network 204; and a primary private network 204. Additional embodiments may include a network 204 of mobile telephone networks that use various protocols to communicate among mobile devices. For short range communications within a wireless local-area network (WLAN), the protocols may include 802.11, Bluetooth, and Near Field Communication (NFC).

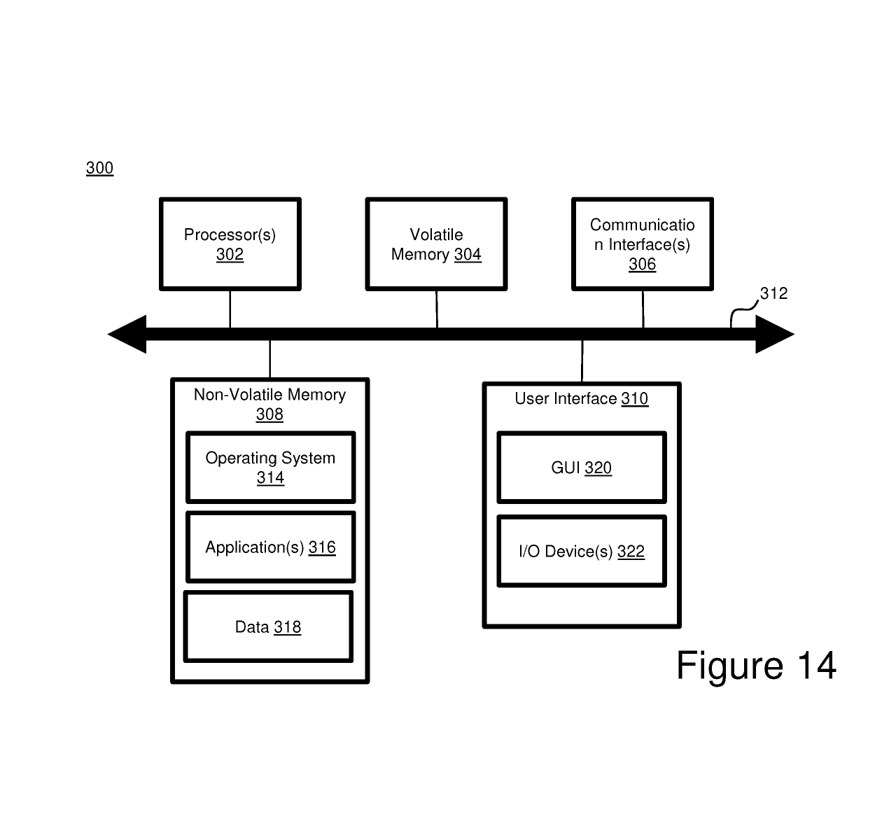

Elements of the described solution may be embodied in a computing system, such as that shown in FIG. 14 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 5 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

What is claimed is:

1. An artificial intelligence (AI) platform implemented in a server, comprising:
an interface configured to handle requests to receive, process, and save data at a plurality of disparate systems that have different graphical user interfaces (GUIs) and that store data in different formats; and
a vision-enabled AI interface (VAI) system configured to receive a task request from the interface and perform processes that include:
deploy a task level model selected from a plurality of task level models trained to perform the task request for an associated disparate system;
execute the task level model to control a vision sensor unit (VSU) and a device controller unit (DCU) to implement the task request without human intervention via an associated dental practice system GUI;
deploy a system level model in response to an error encountered by the task level model; and
execute the system level model to recover from the error.

2. The AI platform of claim 1, wherein the system level model is implemented and executed at the server and the task level model is deployed to and executed at a remote server running the disparate system.

3. The AI platform of claim 1, wherein the plurality of disparate systems comprises disparate dental practice systems.

4. The AI platform of claim 3, wherein different ones of the plurality of task level models are trained to provide charting related tasks, note related tasks, imaging related tasks, and periodontic related tasks.

5. The AI platform of claim 1, further comprising a data normalizer that converts data in different formats to and from a common format.

6. The AI platform of claim 1, further comprising a set of application programming interface (API) services to handle second types of requests to receive, process, and save data at disparate systems.

7. An artificial intelligence (AI) platform implemented in a server, comprising:
a universal dental interface (UDI) configured to render and process records in a common format, wherein the records are obtained from a plurality of disparate dental practice systems that have different graphical user interfaces (GUIs) and that store data in different formats; and
a vision-enabled AI interface (VAI) system configured to receive a task request from the UDI, deploy a task level model selected from a plurality of task level models trained to perform the task request within an associated dental practice system, and utilize the task level model to implement a vision sensor unit (VSU) and a device controller unit (DCU) to perform the task request without human intervention via an associated dental practice system GUI.

8. The AI platform of claim 7, wherein:
the VSU captures screen imagery and detect GUI elements of the associated dental practice system GUI; and
the DCU generates mouse and keyboard control signals to emulate user interaction with the associated dental practice system GUI.

9. The AI platform of claim 7, wherein the VAI system further includes at least one system level model trained to handle errors encountered by any of the plurality of task level models.

10. The AI platform of claim 9, wherein different ones of the plurality of task level models are trained to provide charting related tasks, note related tasks, imaging related tasks, and periodontic related tasks.

11. The AI platform of claim 9, wherein the system level model is implemented and executed in the server and the task level model is deployed to and executed at a remote server running the associated dental practice system.

12. The AI platform of claim 7, wherein the VAI system further includes:
a request handling unit (RHU) that provides an interface between user-initiated requests from the UDI and system-level execution of the user-initiated requests;
an application controller unit (ACU) that receives user-initiated requests from the RHU, and determines intent, extracts parameters, and translates requests into generated task requests; and
an application processing unit (APU) that receives a generated task request from the ACU and coordinates with a remote session manager (RSM) to access a session on the associated dental practice system.

13. The AI platform of claim 12, further comprising a knowledge management unit (KMU) that stores the plurality of task level models, wherein each task level model is trained to learn workflows, task sequences, and operational logic of an associated task request for an associated dental practice system.

14. The AI platform of claim 12, wherein the user-initiated requests include structured and unstructured inputs.

15. The AI platform of claim 12, wherein the user-initiated requests include direct function calls, GUI interactions, and natural language commands.

16. The AI platform of claim 12, further comprising an application training unit configured to train the plurality of task level models.

17. The AI platform of claim 12, further comprising an exception handler unit to provide real-time exception resolution using a system level model trained to recover from detected task level errors.

18. The AI platform of claim 12, wherein the RSM provides session initiation and termination, authentication handling, environment verification, session monitoring, secure channel management multi-session coordination, and session persistence.

19. The AI platform of claim 7, wherein the UDI is configured to:
render a UDI instance on remote devices;
access a record from a selected one of the plurality of disparate dental practice systems and convert the record from a disparate format to the common format;
display the record from the selected disparate dental practice system within the UDI instance; and
process the record in the UDI instance to generate a processed record.

20. An artificial intelligence method, comprising:
receiving a user initiated request at a cloud server from a client device to obtain, process or save a dental record at a selected dental practice system selected from a plurality of disparate dental practice systems;
processing the user-initiated request and generating a task process;
selecting a task level model from a plurality of task level models and deploying the task level model to a remote dental practice server running the selected dental practice system;
receiving a notification of either a completed task process or a failed task process from the task level model; and
in response to the failed task process, deploying a system level model at the cloud server to recover from the failed task process, wherein recovering from the failed task process includes successfully autocorrecting the failed task process or requesting a user to manually correct the failed task process.
